(19) United States
(12) Patent Application Publication
(10) Pub. No.: US 2011/0256516 A1
(43) Pub. Date: Oct. 20, 2011

(54) Youth depot / Youth Hub

(76) Inventor: Jacquelyne M. Cody, Brooklyn, NY (US)

(21) Appl. No.: 12/799,091

(22) Filed: Apr. 19, 2010

(51) Int. Cl. G09B 19/00

(52) U.S. Cl. 434/236

(57) ABSTRACT

The Youth Depot is a 24-hour-one-stop-shop of services and activities for teens and young adults. The Youth Depot is a collaboration/partnership of two or more youth-service-organizations coming together at one location. The Youth Depot ensures that each and every individual teen that enters will be connected with a Life Advisor-non-judgmental-caring-resourceful-qualified professional.

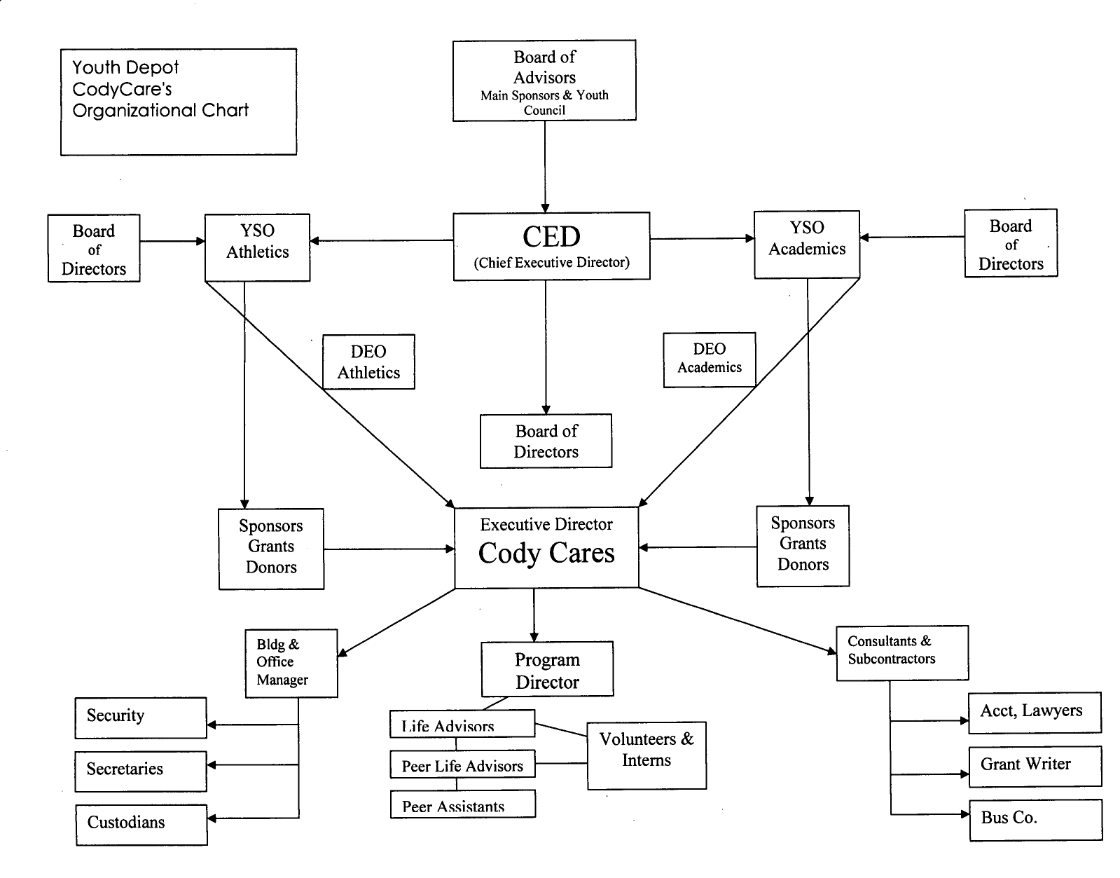

### BACKGROUND OF INVENTION

Right now, our teens suffer from high incarceration, unwanted teen pregnancies and the spread of HIV, high school drop-out rates, low graduation rates, gang violence, and other destructive ills that plague children daily. Guidance Counselors in public schools have such enormous caseloads that it makes it virtually impossible to attend to all of the educational needs of their students. Plainly, the “village” that it takes to raise a child is not in working order. Parents are not always unavailable for negative reasons.

Our children need constructive things to do, places to go and productively gather, positive role models to connect with, and practical opportunities to exercise in a safe space.

### BRIEF SUMMARY OF THE INVENTION

The Youth Depot is a 24-hour-one-stop-shop of services and activities for teens and young adults. The Youth Depot is a collaboration/partnership of two or more youth-service-organizations coming together at one location. The key difference between the Youth Depot and any other youth center is that each and every individual teen that enters will be connected with a Life Advisor. CodyCares' Life Advisors equip teens with the tools and techniques necessary to be successful in academia and in life. Life Advisors are non-judgmental, caring, resourceful, qualified professionals who are also able to: facilitate workshops, host events, organize youth-centered activities and fundraisers such as trips, outings, college retreats, sporting events, exhibits, shows, and best of all—prepare teens to become peer life advisors.

### BRIEF DESCRIPTION OF THE SEVERAL VIEWS OF THE DRAWING

See FIGURE I: The Organizational Chart

### DETAILED DESCRIPTION OF THE INVENTION

The mission of the CodyCares for Kids, Inc is to help transform our youth into productive adults by providing them with the tools and techniques on how to live successfully.

CodyCares provides:
the talent and expertise to facilitate the transformation of our youth into leaders
life advisement which is a holistic education that informs youth on how to live productive and successful lives
emotional and mental refuge for youths seeking direction in life
enhancement of life skills and decision-making skills
academics such as study and test-taking skills
tools and techniques on how to maintain healthy relationships
mental and physical health awareness
information on other topics that are relevant to clients knowing themselves better and realizing their life's purpose

CodyCares will serve as the base organization for the Youth Depot. CodyCares will ensure that every teen that walks through the doors of the Youth Depot will be connected with a Life Advisor:
The Youth Depot is an answer and solution to the dilemmas our children face daily. It is a one-stop-shop of youth services and activities.
The Youth Depot will provide the foundation for all other youth service organizations to join together. It will provide a safe place for teens to be themselves and receive the necessary tools and techniques to become successful individuals.
It will also provide a place for sponsors to see clearly the results of their funding. Our model of the Youth Depot can be franchised throughout each Borough, City, State, and Country.

The youth depot will:
be available and accessible during non-school hours as well as summers
provide a mental and emotional refuge for displaced youth
connect every young person who enters with life advisors who will guide teens and young adults towards living very productive and successful lives
prepare youth to be peer life advisors

The Youth Depot will bring together tried and true organizations to make our services more accessible in order to increase the success of youth. So far the following organizations has partnered to for the 1^{st} Youth Depot (Youth Hub) in the U.S.:

| | |
|---|---|
| CodyCares for Kids, Inc. | ENY Scholarship Fund |
| Silver Lining Outreach | Creative Outlet |
| Wings for Youth | Blue Falcons |
| NBTEE Teen (Expo) | Royal Blue Studios |
| Neighborhood Health Providers | Rise to the Occasion |
| F.I.R.S.T. Inc. Youth Empowerment | |
| Organization | |

The collaboration with other Youth Service Organizations (YSOs) will supply all of the following services and activities at one location:
tutoring (help with homework, ESL, test-taking and study skills, etc.)
sports (team and individual sports—basketball, football, tennis, etc.)
games (board games, house games, sports, water games, etc.)
dance (cheerleading, African dance, ballet, tap dance, etc.)
music (band, singing, piano, guitar, drum, chorus, etc.)
health & fitness (weightlifting, yoga, karate, individual & group counseling, etc.)
social clubs (political groups, community & cultural awareness, professional, etc.)
social events (parties, talent shows, concerts, etc.)
S.A.T. Preparation (test-taking skills)
college (help with choosing, applying to, and entering college)
career (help with choosing a career and getting a job)
life skills (money management, time management, etc.)
and so much more

The following information is CodyCares' program for the Youth Depot/Youth Hub:

The Youth Depot's after-school clubs will focus on different topics each month. We have a curriculum that we will follow (see “Curriculum Chart”).

Our after-school clubs will run between 1 p.m. and 7 p.m. (8 p.m. in the spring and early fall). We will accept new clients during the school year or as referred to us through outside agencies and schools.

Our summer clubs will run from 10 a.m.-8 p.m. Monday through Thursday and Fridays and Saturdays from 10 a.m.-10 p.m. We will offer academic workshops from 10 a.m.-12 p.m., dealing with how to enhance necessary life skills. From 1:30 p.m.-4 p.m., clients will engage in supervised clubs.

Clients are free to create clubs that meet CodyCares' goals, but there will be initial clubs for clients to participate in. The clubs that will be initially available are the Engineering Club, the Journalism Club, Political and Community Activist Clubs, and Creative Channel Clubs.

Clients will have from 4 p.m.-7 p.m. to participate in other various activities. Some of these will be team sports, individual sports, and group and individual life advisement sessions.

On Fridays, the clients will be able to stay until 10 p.m. and practice for games or productions.

Saturdays will be open for free time from 10 a.m.-10 p.m. year-round unless otherwise indicated. We will have birthday parties and celebrations until 10 p.m., and clients under 18 must have written consent to attend functions after 7 p.m.

On Sundays, we will close so clients can spend time with their families. We also encourage clients to visit places like museums, aquariums, zoos, movies, parks, and religious institutions with family members. Clients will be asked to bring in reports of their experiences. Their reports can be paintings, songs, essays, poems, dances, or any other positive expression of sharing.

In addition, the youth depot will be available throughout the night to house youth for emergencies, such as being picked up by police, run-aways, domestic violence victims, and other unforeseen trouble that youth may be confronted with. The night duty confidence guardian will contact the executive director to meet with youth at 9 a.m. to quickly ensure follow-up services can appropriately accommodate the youth in trouble.

During the year, we will hold three annual events: a talent show, the Kayla Awards, and Honors Night Our talent show will be held in May for clients to demonstrate their talents and abilities. At the Kayla Awards, clients will be awarded for all their positive achievements, ranging from passing a class they were failing to being accepted into an Ivy League university with a full scholarship. They will be given awards red carpet-style. We plan to have this event at the end of every August. Honors night will be a formal salute held at the end of November to honor, recognize, and thank our sponsors.

A full year is from September to August and new clients who have successfully completed one full year are inducted as CodyCares “family members.” We also reward clients who have completed two years and a book project. This also makes them eligible to become peer advisors.

Literacy skills will be interwoven in all club activities. We will also have other various workshops every year, like sister-to-sister gender, brother-to-brother gender, and peer pressure anonymous workshops. Ideas for workshops will also come from clients and workshops will also be established as needed during the year.

The core project for each client is making a book about his or her life called “My Life.” Clients/members will receive constant guidance and facilitation from their life advisor. This will provide an opportunity for writing in a safe environment, provide a mechanism for defining his or her identity and developing a stronger sense of self, connect and reinforce all subjects covered in workshops, and increase language skills. The books will be displayed at the year-end celebratory event, after which they can be taken home.

The clients will also read and report on autobiographies or biographies of Black Americans of historical significance or who have achieved success in contemporary America. One resource that will reinforce the message of Black importance in America is the Aetna Insurance calendar, which features a Black health care professional each month.

As students explore their own identity, they will be encouraged to create art, essays, songs, etc., which will also be displayed at the end-of-the-year celebration and can be taken home as a tangible curriculum reminder.

### Curriculum

For a detailed analysis, please see the chart on the following page.

To help the curriculum, Jacquelyne Cody's book, How to be Happy, A Guide to Finding True Purpose and Self-empowerment, will be used as a text and reference. The book is interactive with space for students to write their thoughts. The chapters deal with one's purpose in life, understanding one's purpose, how morals and values define people, being happy through maintenance, and celebrating one's greatness through empowerment. Also included in the book are tips on time management, test-taking, studying, and money management.

### Parental Involvement

Parents will be asked to bring their children to register them. This will give the staff an opportunity to have an individual orientation with parents. The staff will explain the incentives and awards given to them along with their child for improved report cards, improved school attendance, parent attendance, and continued club attendance. Hopefully, doing so will engage parents to motivate their children to achieve. There will also be evening meetings for parents and students during each school semester. Parents will be encouraged during these meetings to add something to their children's books.

### Incentives and Awards

Every child who attends the program will receive a personalized certificate and a dictionary. Children who succeed in having an improved report card will receive a board game, such as Trivial Pursuit or Scrabble. All games chosen will require language skills so families and students will be engaged in honing language skills outside the clubs.

### Assessment and Evaluation

| Outcomes | Indicators | Verifications |
|---|---|---|
| Youth remains enrolled | Youth remains enrolled in | Program |
| in program | program until end of | attendance |
| | semester | records |
| Youth maintains school | Youth remains enrolled in | School |
| attendance, does not | school until end of semester | attendance |
| drop out of school | | records |
| Parents participate in | Parents attend evening | Sign-in sheets |
| program | parent-child events, end-of- | |
| | year celebration | |
| Youth improves | Comparison of report cards | Report cards |
| literacy/academic | before and after program | |
| skills. (Expectation: | participation | |
| 90% of youth will | | |
| achieve objective) | | |
| High school senior | School transcripts showing | High school |
| graduates | graduation eligibility | diploma |
| Youth admitted into | Youth shows evidence of | College |
| college | college application | acceptance |
| | | letters |

CODYCARES' CURRICULUM OUTLINE

| 1st Month | 2nd Month | 3rd Month | 4th Month |
|---|---|---|---|
| September/January | October/February | November/March | December/May |
| [symbol] roductory sessions | Educational issues | Careers | Physical/mental/emotional |
| [symbol] ceive books | Skills for succeeding | Dress for success | Health |
| [symbol] tually set semester | Test Taking | Resume | Relationships |
| [symbol] als for the group | Studying | Finances | Family issues |
| [symbol] gin the “My Life” book | Focusing | Budget | Discussion of the link |
| [symbol] ject | College Quest | Time management | between content of |
| | Work on “My Life” | Continue work on “My | workshops and being |
| | | Life” | successful in life |
| | | | Discuss the student's |
| | | | experience in creating “My |
| | | | Life” |
| | | | Finish “My Life” |

[symbol]

indicates data missing or illegible when filed

### Key Roles and Job Descriptions

The Chief Executive Director is the chief executive/officer of the CodyCares working closely with the Board of Directors. The executive director provides the leadership and vision that enables the organization to fulfill its mission and policies through oversight of all of the organization's operations including planning, programs, administration, financial, personnel, fundraising, development and public/community relations. Executive Director is responsible for the management and direction of the organization's operations, as well as keeping track of the appropriate assigning of Life Advisors to Clients. This includes ongoing data analysis of clients' personal information. Also, assists the Board of Directors in its governance responsibilities by fully informing them of the state of the organization's fiscal and programmatic stability, attending board meetings, assigning personnel to partner with the board and its committees; involving the staff in long-range planning and facilitating their fundraising responsibilities; Responsible for the agency's fiscal compliance and program accountability. The Chief Executive Director serves as chief spokesperson for the agency with the media and public by facilitating positive exposure of the agency and its work, communicates the agency's mission to key stakeholders, and collaborating with other community organizations and entities.

The Program Director's (a.k.a. Deputy Directors—Athletic will be in-charge of all sports and athletic programs; and Academic will be in-charge of all non-sport and non-athletic programs) will primary responsibilities are to monitor and ensure success of the program by making sure goals are reached, the guidelines and format of the program are adhered to, and to supervise staff. The Program Director will lead/facilitate workshops and hold individual sessions when necessary. Specifically, when the Life Advisor's caseload has reached the max of 50 participants, or when participants are not in our target population, and or when there are participants that are not positively responding to the Life Advisor, The Program Director will step in for YSOs on location. The Program Director/Deputy Directors will prepare schedule for the use of the facility The Program Director reports to the Chief Executive Director, and acts as the Chief Executive Director in her absence. (The Program Manager assesses, maintains, critiques the program, and provides necessary feedback and recommendation to ensure the success of the program. This role can be fulfilled by a separate individual.)

The Life Advisors' primary responsibilities are to facilitate individual and group sessions, to establish mentoring relationships with participants, to use CodyCares' curriculum to plan appropriate workshops for participants to understand, to monitor and supervise peer life advisors, and to guide each participant towards reaching the goals of the program. Life Advisors can maintain an annual caseload of 45-50 individual participants. Workshops can include 10-15 participants and will focus on topics deemed necessary by the Life Advisor for the participants' overall growth and self-confidence. Life Advisors are also responsible in maintaining a confidential file on all participants. This file will include attendance, a completed Happy Life Application, progress and attendance reports in program, copies of report cards from school, and other pertinent information needed to keep track of participants' growth and overall success in academia and in life.

The Peer Life Advisors' primary duties are to remain in constant communication with participants on the Life Advisor's caseload and ensure their participation by establishing positive peer-mentoring relationships. They will act as conduits for establishing the buddy-system among participants. Peer Life Advisors can and will also do home visits if a participant missed a scheduled individual session; they can and will also facilitate group workshops in schools at the participants' request and approval of school's administration. Peer Life Advisors report bi-weekly to the Life Advisors the progress/status of all participants. Peer Life Advisors are preferably from the same local community of the participants and at least one is bilingual-Spanish or multi-lingual—Creole, Spanish, French, and English.

Consultants are hired to carry out specific duties: Grant Writers, Computer Specialists, Accountant, Attorney, and Developers are not on our payroll, but are needed from time to time to complete work that is critical to the life of our organization.

### CodyCares' Theoretical Foundation

CodyCares' life advisement techniques are based upon the proven experiences and practices of its founder and the conceptual frameworks of Asa G. Hilliard III and Howard Gardner.

Hilliard (1998) said “[t]he purpose of education was not to speed through a four year program to get a job and ‘get paid’ but rather to become a better person and to learn how to live in harmony with nature utilizing whatever skill you have” (p. 6). It is the responsibility of the village to be actively involved in helping each child become a better person. Hilliard further stated that the academic successes of black American children is hindered when we just look to catch up with the scores of white students and try and close the gap that exists between the academic scores of black and white children.

Perry, Steele, and Hilliard (2004) argue that “intelligence tests are nothing more than a particular kind of ‘achievement test’ that favors students who have a privileged opportunity to be exposed to things being measured on the tests” (p. 135). They further stated that “by using the European students' normative performance as the universal standard, not only do we use a low standard, but we tend to be satisfied with the performance of minority cultural groups when a substantial reduction in this gap occurs” (p. 138).

In fact, according to Perry, Steele, and Hilliard (2004), the United States ranks near last in almost all of the comparative international studies of achievement among nations within the “developed world” (p. 137). Thus, the unconscious assumption seems to be that the traditional low performers cannot surpass but merely approach the performance of the norm group. In other words, closing the gap may not be the best academic achievement for black students. It is the levels of excellence that educators should aim for. “When we choose excellent performance as the goal,” Perry, Steele, and Hilliard (2004) explain, “academically and socially, we change the teaching and learning paradigm in fundamental ways.”

We have to plan not just for the future of Black Americans, but for the actual future of education and where we will be in 20 years. Hopefully, we will have graduated beyond scores, numbers, and rating students just by the results on “achievement” and “intelligence” tests. As Ross (2004) asked, “If we are to be concerned that more than 98 percent of Black Americans score below 700 on the Scholastic Achievement Tests (SATs), should we not also be concerned that more than 94 percent of White students do, too?” (p. 159).

Gardner (2005) said that we have to cultivate five kinds of minds if we want to be successful as a nation:
a disciplined mind that can think well and appropriately in the major discipline
a synthesizing mind that can sift through a large amount of information, decide what is important, and put it together in ways to make sense for oneself and others
a creative mind that can raise new questions, come up with novel solutions, and think outside the box
a respectful mind that honors the differences among individuals and groups and tries to understand and work productively with them
an ethical mind that thinks beyond selfish interests, about the kind of worker one aspires to be, and the kind of citizen one should be

Even though it is stated differently, Hilliard's (1998) and Gardner's (2005) educational objections were synthesized to create this conceptual framework: where Hilliard talks about “skills” and Gardner about “major discipline,” Hilliard talks about “better person” and Gardner about “respectful mind,” Hilliard talks about “deep thought” (p. 7) and Gardner refers to it as a “synthesizing mind and creative mind,” and Hilliard talks about “responsibility to community and living in harmony with nature” and Gardner about an “ethical mind.”

Therefore, the following thoughts are:
1. Recognition of self and talents. We look at how the clients see themselves and recognize their own gifts and talents. We explore how these natural skills can help them succeed.
2. Insight and intellect. We examine how each client thinks beyond their immediate circumstance and tries to understand the “big picture” and how things work together. This includes politics, academia, social issues, and everyday life conditions.
3. Resourcefulness and ingenuity. We observe how the clients are able to rise above various obstacles and create or use their situation to improve their status.
4. External social factors. We keep in mind and consider external social factors like family, educators, and community members that have influences and enable clients to be successful.
   We rely upon these thoughts as a conceptual framework to help clients grow and understand themselves in order for them to realize their purposes and paths in life.

CodyCares, as the base for the youth depot, will be a central place where we can all pass on our legacies and live securely knowing that generations will socially evolve. The human race has yet to see the social wonders our minds can generate. We have advanced greatly through our technological resources, but our social resources have remained the same.

We believe that the more people reach self-actualization, the less strife and degradation we will see in the world. The Youth Depot provides the opportunity to succeed academically and in life. Education is life and life is education. A win-win for all!
All children deserve every resource needed to help them reach their full potential, and access to the services that can effectively guide them there. In addition, the Youth Depot will provide a 24-hour safe haven of services and activities that will keep teens and young adults engaged in becoming productive, dynamic, community conscious citizens. In short, either we build Youth Depots or more prisons.

### REFERENCES

Cody, J. M. (2008). How to be Happy: A guide to finding true purpose and self-empowerment. New York: Strategic Publishing.

Gardner, H. (2005). Beyond the herd mentality: The minds we truly need in the future. Educational Weekly, 25(3), 44.

Hilliard, A. G. (1998). Sba: The reawakening of the African mind. Gainesville, Fla.: Makare Publishers.

1. Dr. Jacquelyne Cody claims the right to protect the patent of the Youth Depot:
I. Collaboration of two or more organizations under one roof and or at one location to be of service to teens and young adults ages 13-25
II. Connection of Life Advisors/Mentors/Positive Role Models/Non-judgmental-caring-adults to teens and young adults
III. Collaboration of two or more organizations under one roof and or at one location to be of service to teens and young adults ages 13-25, that provides teens and young adults with a connection to Life Advisors/Mentors/Positive Role Models/Non-judgmental-caring-adults
